(19) United States
(12) Patent Application Publication
(10) Pub. No.: US 2024/0279766 A1
(43) Pub. Date: Aug. 22, 2024

(54) A METAL AGGLOMERATE PRODUCTION CONFIGURATION

(71) Applicant: LUOSSAVAARA-KIIRUNAVAARA AB, LULEÅ (SE)

(72) Inventors: Johan SANDBERG, Luleå (SE); Samuel NORDGREN, Luleå (SE)

(21) Appl. No.: 18/568,536

(22) PCT Filed: Jun. 7, 2022
(86) PCT No.: PCT/SE2022/050557

§ 371 Date: Dec. 8, 2023

(30) Foreign Application Priority Data
Jun. 10, 2021 (SE) 2150736-3

(51) Int. Cl. C22B 1/16; C22B 1/26; F27B 15/18; F27D 15/02; F27D 17/00

(52) U.S. Cl. CPC C22B 1/16; C22B 1/26; F27B 15/18; F27D 15/02; F27D 17/004

(57) ABSTRACT

A metal agglomerate production configuration including an induration apparatus configured to provide a metal oxide material manufacturing thermal process (MTE) including indurating a metal ore material into a metal oxide material and a method of production of metal agglomerates. A cooler device is configured for cooling the metal oxide material discharged from the induration apparatus and includes a first heat transferring arrangement configured for transferring a first heat energy content (HE′) to the induration apparatus, which first heat energy content (HE′) is recovered from the metal oxide material holding the thermal energy (TE). The configuration includes a second heat transferring arrangement configured for transferring a second heat energy content (HE″) from the induration apparatus to the cooler device for cooling of the metal oxide material, which second heat energy content (HE″) is recovered from the metal oxide material manufacturing thermal process (MTE).

### TECHNICAL FIELD

The present invention relates to a metal agglomerate production configuration according to claim 1 and further relates to a method of production of metal oxide material according to claim 7. The present invention further relates to a data medium configured for storing a data program, programmed with a program code adapted for causing the metal agglomerate production configuration to execute an automatic or semi-automatic manufacture of metal oxide material.

The present invention concerns the mining industry and the metal material making industry. The present invention concerns metallurgical process industry producing industrial metal oxide materials, such as iron oxide agglomerates or other types of metal oxide material. The present invention also may concern manufacturers and suppliers of metal agglomerate production configurations.

Especially, the present invention may concern steel making industries processing ferrous metals, such as steel. However, the present invention may also concern other types of metal producers, processing non-ferrous metals, such as aluminium, copper, lead and zinc.

### BACKGROUND

Metal oxide material is produced by heating metal ore material at a production site comprising an induration arrangement configured to indurate the metal ore material producing metal oxide material of high temperature. Subsequently, the metal oxide material is cooled down by a cooler and is distributed from the production site. The metal oxide material may be iron oxide material, e.g. iron oxide pellets or other form of agglomerates, transported to the metal producing industries, such as steel producers.

The induration arrangement or the induration apparatus may be part of a pelletizing process, such as a straight grate process or grate-kiln process. In the straight grate process, the metal ore material or green pellets may be moved on a continuous grate through different zones for drying, oxidation, sintering. The straight grate process additionally comprises a cooler unit configured for cooling down the metal oxide material. The grate-kiln process may use a shorter grate coupled to a rotary kiln in order to achieve a homogenous heat treatment of the metal ore material.

Known production sites for production of metal oxide material uses fluid transfer arrangements for recirculating waste heat energy content in order to decrease the fuel consumption and to achieve efficient energy use.

There are different implementations of heated fluid gas recirculation in such production sites. Prior art production sites may use exhaust heat recovered from the cooler device for drying and preheating the metal ore material in the induration apparatus.

One problem with prior art production sites is that they do not optimize the recovery of exhaust heat.

One problem with prior art production sites is that they may produce dust emissions due to insufficiently cooled down metal oxide material leaving the cooler device.

One problem with prior art production sites is that they may damage conveyor arrangements discharging insufficiently cooled metal oxide material.

One problem with prior art production sites is that they may involve costly metal oxide material separations today provided for separating metal oxide agglomerates with different temperature content.

### SUMMARY OF THE INVENTION

There is an object to develop known techniques for utilization of waste heat in a metal agglomerate production configuration.

There is an object to provide a metal agglomerate production configuration that operates energy efficient.

There is an object to provide a metal agglomerate production configuration that promotes efficient control and operation of the induration apparatus and the cooler device.

There is an object to increase the production rate of the metal agglomerate production configuration.

There is an object to minimize the energy consumption for operating the metal agglomerate production configuration.

There is an object to provide a metal agglomerate production configuration that enables efficient control of the heat energy content fed from the cooler device to the induration apparatus.

There is an object to provide a metal agglomerate production configuration that provides high temperature in the firing zone of the induration apparatus, such as a temperature of about 1000-1100° C. or higher.

There is an object to decrease the heat work in the oxidization phase of the metal ore material and/or metal oxide material in the induration apparatus and/or in the cooler device.

There is an object to reduce fossil carbon emissions by decreasing the use of coal or oil to heat the metal ore material in the induration apparatus.

There is an object to provide time-saving production of the metal oxide material.

There is an object to provide decreased rate in cooling of the metal oxide material for providing a stable cooling of the metal oxide material within the cooler device.

There is an object to provide a metal agglomerate production configuration that produces metal oxide material, such as iron ore pellets, having low thermal energy when being discharged from the cooler device.

There is an object to provide constantly and/or stable generation of thermal energy (heat) by the cooler device, from a plurality of cooler zones, and/or especially from an outermost positioned cooler zone of the cooler device.

There is an object to provide an operation of a metal agglomerate production configuration that promotes stable and constant production of metal oxide material to be charged into a reduction facility configured to produce metal material, such as sponge iron.

There is an object to optimize the heat energy content generated by the outermost positioned cooler zone and optimize the heat energy content to be re-used by the induration apparatus for production of the metal oxide material, at the same time as an environment friendly process is achieved for production of metal agglomerates.

There is an object to provide a metal agglomerate production configuration that can be operated in an energy efficient way independently from specific season periods (e.g. winter and summer periods).

There is an object to minimize the loss of heat of condensation from the cooler device.

There is an object to provide a metal agglomerate production configuration that promotes efficient control of the production of the metal oxide material.

There is an object minimize utilization of electrical power required by the induration apparatus.

There is an object to increase the temperature and/or mass flow of the fluid carrying the first heat energy content transferred to the induration apparatus from the cooler device.

There is an object to enabling efficient control of operation of the metal agglomerate production configuration for accurately providing pre-determined properties of the finished metal oxide material

There is an object to provide energy-efficient re-use of heat from the finished metal oxide material.

There is an object to decrease the temperature of the finished metal oxide material, thus avoiding e.g. dust emissions, preventing metal oxide material conveyor arrangements to be heat damaged, avoiding costly metal oxide material separation after discharge.

This or at least one of said objects has been achieved by a metal agglomerate production configuration as claimed by claim 1.

Alternatively, the second heat transferring arrangement is configured for transferring a second heat energy content from the induration apparatus to the cooler device for providing decreased cooling rate of cooling down the metal oxide material, which second heat energy content is recovered from the metal oxide material manufacturing thermal process.

Alternatively, the first heat energy content constitutes a portion of the thermal energy originating from said metal oxide material manufacturing thermal process.

Alternatively, the second heat energy content comprises low-grade heat energy recovered from the induration apparatus.

Alternatively, the second heat energy content partially is added to the first heat energy content.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

Alternatively, the second heat transferring arrangement comprises a first air cooling chamber configured for cooling the metal oxide material in a first step and comprises a second air cooling chamber configured for cooling the metal oxide material in a second step.

Alternatively, a heat exchanger unit of the second heat transferring arrangement is coupled between the induration apparatus and the cooler device.

Alternatively, the control circuitry of the metal agglomerate production configuration is configured to control said metal oxide material manufacturing thermal process from monitoring the first heat energy content and/or the second heat energy content.

Alternatively, the control circuitry of the metal agglomerate production configuration is configured to control the metal oxide material manufacturing thermal process by taking into account the temperature and/or mass flow of the first heat energy content and/or the second heat energy content.

Alternatively, the cooler device comprises an annular cooler, a belt cooler, a vertical cooler etc. or any other cooler device configured for providing high cooling efficiency, cost-effective maintenance and service, compact installation and low energy consumption.

Alternatively, the cooler device is configured for additional oxidization of the metal oxide material for decreasing the FeO content and enhancing the quality of the finished metal oxide material.

Alternatively, the induration apparatus comprises a drying zone, configured to dry the metal ore material, a pre-heating zone configured to pre-heat the metal ore material, an oxidizing zone configured to oxidize the metal ore material and a sintering zone configured to sinter the pre-heated and oxidized metal ore material.

Alternatively, the cooler device comprises a first air cooling chamber (first cooler zone) and/or a second air cooling chamber (second cooler zone) and/or a third air cooling chamber (third cooler zone) and/or a fourth air cooling chamber (fourth cooler zone) and/or a fifth air cooling chamber (fifth cooler zone).

In such way it is achieved that the thermal energy derived from the metal oxide material may be transferred to the induration apparatus and/or to an external commercial heat provider, such as a heat distribution company.

Alternatively, the drying zone comprises an updraft drying chamber (an updraft zone) and/or a downdraft drying chamber (a downdraft zone).

Alternatively, the updraft drying chamber and/or the downdraft drying chamber being configured to be heated by means of a combustion burner device and/or by means of an electrical heating element and/or by means of a hydrogen burner and/or by means of exhaust heat recovered from the cooler device.

Alternatively, the induration apparatus comprises a tempered pre-heating chamber (tempered pre-heating zone).

Alternatively, the induration apparatus comprises a pre-heating chamber (pre-heating zone).

Alternatively, the metal ore material is subjected to be transferred through the induration apparatus in the following order; firstly through the drying zone, and/or through the tempered pre-heating zone, and/or through the pre-heating zone, and/or through the oxidizing zone, and/or through the sintering zone.

Alternatively, the metal oxide material transferred from the induration apparatus into the cooler device may have a temperature of about 1200-1300° C.

Alternatively, the induration apparatus is configured to transfer heat energy content to/from the cooler device via a pipe arrangement configured for transfer of heated fluid, and furthermore configured to convey metal ore material and/or metal oxide material within the induration apparatus and to the cooler device at the same time as oxidation of the metal ore material takes place within the induration apparatus, and furthermore configured to transfer heated excess heat energy comprising low-grade heat energy to the cooler device.

Alternatively, the cooler device is configured to cool down the metal oxide material to a temperature lower than a temperature of about 100-200° C.

Alternatively, the cooler device comprises a support member configured to support the metal oxide material.

Alternatively, the support member is configured to support the metal oxide material and/or is configured to store thermal energy and/or emit thermal energy.

Alternatively, the support member is configured to store thermal energy from the metal oxide material and is configured to store the second heat energy content and/or is configured to emit the first heat energy content to the induration apparatus.

Alternatively, the support member is configured to cool down the metal oxide material, wherein the first heat energy content partially comprises the second heat energy content.

Alternatively, the metal oxide material is uniformly distributed on the support member of the cooler device.

Alternatively, the cooler device comprises a first cooler zone, a second cooler zone, a third cooler zone, a fourth cooler zone and a fifth cooler zone.

Alternatively, the metal oxide material is subjected to be transferred through the cooler device in the following order; firstly through the first cooler zone, and/or through the second cooler zone, and/or through the third cooler zone, and/or through the fourth cooler zone and/or through the fifth cooler zone.

Alternatively, the metal oxide material is subjected to be transferred from the sintering zone to the first cooler zone.

Alternatively, exhaust heat energy is recovered from a downdraft drying zone and/or updraft drying zone and/or tempered pre-heating zone and/or pre-heating zone of the induration apparatus, which exhaust heat energy is transferred directly or via a heat exchanger apparatus into a first and/or second air cooling chamber of the cooler device.

In such way is achieved energy efficient operation of the metal agglomerate production configuration, by making use of the exhaust heat energy (low-grade heat energy) and at the same time decreasing the cooling rate of cooling down the metal oxide material in the cooler device in a controllable manner and recovering the exhaust heat energy from the cooler device.

Alternatively, the sintering zone is formed in a furnace device, such as a kiln device or any suitable firing device configured for sintering the metal ore material, wherein the furnace device is configured for sintering the metal ore material involving that the metal ore material is subjected to heating and/or firing so that metal particles of the metal ore material partially melt.

Alternatively, the heating and/or firing of the metal ore material is provided by means of a gas burner device and/or an electrical heat member associated with the sintering zone.

Alternatively, the second heat energy content is partially or completely added to the metal oxide material to be discharged from the cooler device.

Alternatively, low-grade heat energy, such as heated waste gas, is transferred from the induration apparatus to the cooler device.

It has been shown by the applicant that it is possibly to decrease, by means of the first heat energy content, the heat work in the induration apparatus with up to about 25-30%.

The decreased rate of cooling promotes that the heated metal oxide material can be retained over long time in the cooler device, whereas the heat is available to be re-used all the way through the cooler device.

Alternatively, a compressor device is coupled to the first and/or second pipe arrangement for compressing the process gas.

Alternatively, the cooler device comprises a heat storage element configured to store a first heat energy storage content, transferred from the metal oxide material to the heat storage element.

Alternatively, the heat storage element is configured to store a second heat energy storage content of the second heat energy content transferred from the induration apparatus by means of the second heat transferring arrangement.

Alternatively, the heat storage element is configured to completely or partially store the first heat energy content and/or completely or partially store the second heat energy content and/or completely or partially store the first heat energy storage content and/or completely or partially store the second heat energy storage content.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

Alternatively, cooler device comprises a first cooler zone, a second cooler zone, a third cooler zone, a fourth cooler zone and a fifth cooler zone.

Alternatively, the cooler device comprises a heat storage element configured to store a first heat energy storage content, transferred from the metal oxide material to the heat storage element.

Alternatively, the heat storage element is configured to store a second heat energy storage content, transferred from the second heat energy content transferred from the induration apparatus.

Alternatively, the second heat energy content is transferred to the metal oxide material to be discharged from the cooler device.

Alternatively, a first heat transferring arrangement of the cooler device and/or a second heat transferring arrangement completely or partially constituting the heat storage element.

Alternatively, the second heat energy content is completely or partially added to the first heat energy content and being transferred back to the induration apparatus.

Alternatively, the heat storage element is configured for transferring heat energy to the induration apparatus (e.g. to the drying zone and/or tempered pre-heat zone and/or the pre-heat zone and/or the oxidization zone and/or the sintering zone).

Alternatively, the heat storage element is configured to emit the support member thermal energy by means of convection and/or radiation.

Alternatively, the heat storage element is formed as said support member being configured to store thermal energy from the metal oxide material and is configured to store the second heat energy content and/or is configured to emit the first heat energy content to the induration apparatus.

Alternatively, the first heat energy content is recovered (partially or completely) from the metal oxide material holding the thermal energy originating from the metal oxide material manufacturing thermal process provided by the induration apparatus.

Alternatively, the heat storage element is configured to absorb the first heat energy content (partially or completely) from the metal oxide material discharged from the induration apparatus to the cooler device and is configured to absorb the second heat energy content of low grade heat (exhaust heat) recovered from the induration apparatus (e.g. recovered from the drying zone and/or the heating zone and/or the oxidization zone and/or the sintering zone).

Alternatively, the heat storage element comprises a first heat storage element and a second heat storage element.

Alternatively, first heat storage element and the second heat storage element being configured to store the first heat energy storage content.

Alternatively, first heat storage element and the second heat storage element being configured to store the second heat energy storage content.

Alternatively, the first heat storage element is arranged in a first air cooling chamber of the first cooler zone.

Alternatively, the second heat storage element is arranged in a second air cooling chamber of the second cooler zone.

Alternatively, the second heat energy content of low grade heat (exhaust heat) recovered from the induration apparatus is fed from a heat exchanger apparatus transferring heat from exhaust gases to a process gas carrying the second heat energy content.

This or at least one of said objects has been achieved by a method of production of metal agglomerates according to claim 7.

Alternatively, the second heat energy content comprises low-grade heat energy recovered from the induration apparatus.

Alternatively, the second heat energy content completely or partially is added to the first heat energy content.

Alternatively, the step of cooling comprises the steps of; storing the thermal energy and the second heat energy content by means of a heat storage element of the cooler device; emitting the first heat energy content from the cooler device to the induration apparatus.

Alternatively, the metal ore material and/or the metal oxide material being in the form of agglomerates, such as pellets or any suitable form.

The metal ore material may be in the form of so called green pellets.

In such way is achieved, that the metal ore material being collected in the indurating apparatus (such as a rotary kiln unit, a straight grate, or other oxidation and/or sintering apparatus) for drying, pre-heating and/or oxidation of the metal ore material, that the open spaces provide efficient oxidizing process of the metal ore material.

Alternatively, the metal oxide material may comprise metal oxide agglomerates,

Alternatively, the metal oxide material may comprise iron oxide agglomerates.

Alternatively, the thermal energy derived from the finished metal oxide material may be used for adding the temperature of process water or buildings.

The wording “metal ore material” and “metal oxide material” may be replaced by the wording “iron ore material” and “iron oxide material”.

The present disclosure or disclosures may not be restricted to the examples described above, but many possibilities to modifications, or combinations of the described examples thereof should be apparent to a person with ordinary skill in the art without departing from the basic idea as defined in the appended claims. For example, the induration apparatus may be positioned adjacent to the cooler device.

### BRIEF DESCRIPTION OF THE DRAWINGS

The present invention will now be described by way of examples with references to the accompanying schematic drawings, of which:

FIG. 1 illustrates a metal agglomerate production configuration according to a first example;

FIG. 2 illustrates a metal agglomerate production configuration according to a second example;

FIG. 3 illustrates a metal agglomerate production configuration according to a third example;

FIG. 4 illustrates a metal agglomerate production configuration according to a fourth example;

FIG. 5 illustrates a metal agglomerate production configuration according to a fifth example;

FIG. 6 illustrates a cooler device of a metal agglomerate production configuration according to a sixth example;

FIG. 7 illustrates a cooler device of a metal agglomerate production configuration according to a seventh example;

FIG. 8 illustrates a metal agglomerate production configuration according to an eight example;

FIG. 9 illustrates a metal agglomerate production configuration according to a ninth example;

FIG. 10 illustrates a flowchart showing an exemplary method of production of metal agglomerates;

FIG. 11 illustrates a flowchart showing an exemplary method of production of metal agglomerates; and

FIG. 12 illustrates a control circuitry of an exemplary metal agglomerate production configuration.

### DETAILED DESCRIPTION

Hereinafter, exemplary embodiments of the present invention will be described with reference to the accompanying drawings, wherein for the sake of clarity and understanding of the invention some details of no importance may be deleted from the drawings.

FIG. 1 illustrates a metal agglomerate production configuration 1 comprising an induration apparatus 3 configured to provide a metal oxide material manufacturing thermal process. The metal oxide material manufacturing thermal process comprises a step of indurating a metal ore material 5 into a metal oxide material 7 by means of a heating device 31. The induration apparatus 3 is configured to discharge the metal oxide material 7 to a cooler device 9 of the configuration 1, whereas the metal oxide material 7 transferred to the cooler device 9 holds thermal energy originating from the metal oxide material manufacturing thermal process. A control circuitry 50 of the metal agglomerate production configuration 1 is configured to control the metal oxide material manufacturing thermal process and is configured to control the cooling of the metal oxide material 7. The cooler device 9 is configured for cooling the metal oxide material 7 discharged from the induration apparatus 3. The cooled metal oxide material is marked with the reference sign 10.

The cooler device 9 comprises a first heat transferring arrangement 11 configured for transferring a first heat energy content HE′ to the induration apparatus 3. The first heat energy content HE′ partly is recovered from the metal oxide material 7 holding the thermal energy.

The metal agglomerate production configuration 1 comprises a second heat transferring arrangement 13 configured for transferring a second heat energy content HE″ from the induration apparatus 3 to the cooler device 9 for providing the cooling of the metal oxide material 7.

The second heat energy content HE″ is generated by the metal oxide material manufacturing thermal process of the induration apparatus 3. The second heat energy content HE″ thus being recovered from the metal oxide material manufacturing thermal process.

The second heat energy content HE″ may comprise low-grade heat, so called exhaust heat, generated by the induration apparatus 3 and being recovered from the induration apparatus 3 (e.g. recovered from a drying zone and/or a pre-heating zone and/or an oxidizing zone and/or a sintering zone).

Alternatively, further superfluous heat of the metal oxide material 7 discharged from the cooler device 9 may be extracted by an additional cooler zone ACZ and transferred back to the induration apparatus 3 and/or to an external commercial heat provider 8, such as a heat distribution company.

Alternatively, the cooler device 9 comprises metal oxide material discharge device 10 for discharging cooled metal oxide material 7.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

In such way is achieved energy efficient operation of the metal agglomerate production configuration 1, by making use of the exhaust heat energy (low-grade heat energy), and at the same time the cooling rate of cooling down the metal oxide material in the cooler device 9 is decreased in a controllable manner and recovering the exhaust heat energy from the cooler device.

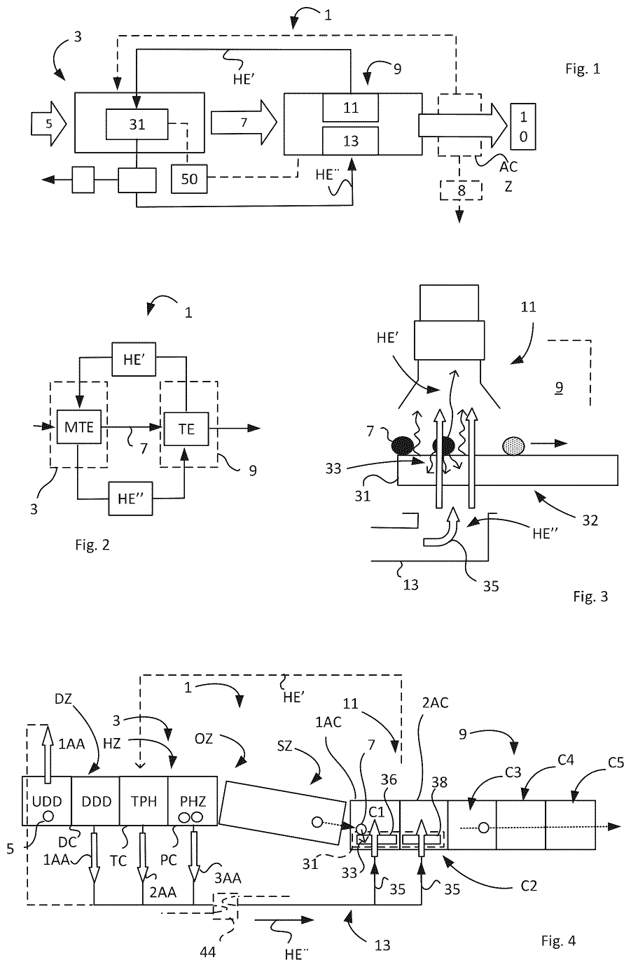

FIG. 2 illustrates a metal agglomerate production configuration 1 according to a second example. A first heat energy content HE′ is transferred to an induration apparatus 3 from a cooler device 9, which first heat energy content HE′ partly is recovered from a metal oxide material 7 holding thermal energy TE provided by the induration apparatus 3. A second heat energy content HE″ is transferred from the induration apparatus 3 to the cooler device 9 for cooling down the metal oxide material 7. The metal oxide material 7 holds thermal energy TE originating from the metal oxide material manufacturing thermal process MTE.

By transferring the second heat energy content HE″ (low-grade heat energy) to the cooler device 9, which second heat energy content HE″ is recovered from the induration apparatus 3 providing a metal oxide material manufacturing thermal process MTE, and by making use of this low-grade heat energy for cooling, the cooling rate to cool down the metal oxide material 7 will be decreased relatively prior art coolers at the same time as the low-grade heat energy from the induration apparatus 3 efficiently being re-used.

FIG. 3 illustrates a cooler device 9 of metal agglomerate production configuration according to a third example. The cooler device 9 comprises a first heat transferring arrangement 11 configured for transferring a first heat energy content HE′ to an induration apparatus (not shown). The first heat energy content HE′ partly is recovered from the metal oxide material 7 holding thermal energy originating from a metal oxide material manufacturing thermal process MTE provided by the induration apparatus. The metal agglomerate production configuration comprises a second heat transferring arrangement 13 configured for transferring a second heat energy content HE″ from the induration apparatus to the cooler device 9 for providing the cooling of the metal oxide material 7.

The cooler device 9 comprises a heat storage element 31 configured to store a first heat energy storage content 33, transferred from the metal oxide material 7 to the heat storage element 31, which metal oxide material 7 is discharged from the induration apparatus into the cooler device 9.

Alternatively, the heat storage element 31 is configured to store a second heat energy storage content 35 of the second heat energy content HE″ transferred from the induration apparatus by means of the second heat transferring arrangement 13.

Alternatively, the heat storage element 31 is configured to completely or partially store the first heat energy content HE′ and/or completely or partially store the second heat energy content HE″ and/or completely or partially store the first heat energy storage content 33 and/or completely or partially store the second heat energy storage content 35.

Alternatively, the heat storage element 31 is formed as a support member 32 configured to support the metal oxide material 7.

Alternatively, the support member 32 is configured to support the metal oxide material 7 and/or is configured to store thermal energy and/or emit thermal energy.

Alternatively, the support member 32 is configured to store thermal energy from the metal oxide material 7 and is configured to store the second heat energy content HE″ and/or is configured to emit the first heat energy content HE′ to the induration apparatus.

Alternatively, the support member 32 is configured to cool down the metal oxide material 7, wherein the first heat energy content HE′ partially comprises the second heat energy content HE″.

Alternatively, the metal oxide material 7 is uniformly distributed on the support member 32 of the cooler device 9.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

FIG. 4 illustrates a metal agglomerate production configuration 1 according to a fourth example.

An induration apparatus 3 comprises a drying zone DZ, configured to dry the metal ore material 5. Alternatively, the drying zone DZ comprises an updraft drying zone UDD and/or a downdraft drying zone DDD.

The induration apparatus 3 further comprises a heating zone HZ configured to pre-heat the metal ore material 5. The heating zone HZ may comprise a tempered pre-heating zone TPH and a pre-heating zone PHZ.

The induration apparatus 3 further comprises an oxidizing zone OZ configured to oxidize the metal ore material 5 and a sintering zone SZ configured to sinter the pre-heated and oxidized metal ore material 5 into a metal oxide material 7 holding thermal energy originating from a metal oxide material manufacturing thermal process provided by the induration apparatus 3.

The metal oxide material 7 holding said thermal energy is transferred from the induration apparatus 3 to a cooler device 9.

Alternatively, cooler device 9 comprises a first cooler zone C1, a second cooler zone C2, a third cooler zone C3, a fourth cooler zone C4 and a fifth cooler zone C5.

Alternatively, the cooler device 9 comprises a heat storage element 31 configured to store a first heat energy storage content 33, transferred from the metal oxide material 7 to the heat storage element 31.

Alternatively, the heat storage element 31 is configured to store a second heat energy storage content 35, transferred from the second heat energy content HE″ transferred from the induration apparatus.

Alternatively, the second heat energy content HE″ is transferred to the metal oxide material 7 to be discharged from the cooler device 9.

Alternatively, a first heat transferring arrangement of the cooler device 9 and/or a second heat transferring arrangement completely or partially constituting the heat storage element 31.

Alternatively, the second heat energy content HE″ is completely or partially added to the first heat energy content HE′ and being transferred back to the induration apparatus 3.

Alternatively, the heat storage element 31 is configured for transferring heat energy to the induration apparatus 3 (e.g. to the drying zone DZ and/or tempered pre-heat zone TPH and/or the pre-heat zone PHZ and/or the oxidization zone OZ and/or the sintering zone SZ).

Alternatively, the heat storage element 31 is configured to emit the support member thermal energy by means of convection and/or radiation.

Alternatively, the heat storage element 31 is formed as a support member being configured to store thermal energy from the metal oxide material 7 and is configured to store the second heat energy content HE″ and/or is configured to emit the first heat energy content HE′ to the induration apparatus 3.

Alternatively, the first heat energy content HE′ is recovered (partially or completely) from the metal oxide material 7 holding the thermal energy originating from the metal oxide material manufacturing thermal process provided by the induration apparatus 3.

Alternatively, the heat storage element 31 is configured to absorb the first heat energy content HE′ (partially or completely) from the metal oxide material 7 discharged from the induration apparatus 3 to the cooler device 9 and is configured to absorb the second heat energy content HE″ of low grade heat (exhaust heat) recovered from the induration apparatus 3 (e.g. recovered from the drying zone DZ and/or the heating zone HZ and/or the oxidization zone OZ and/or the sintering zone SZ).

Alternatively, the heat storage element 31 comprises a first heat storage element 36 and a second heat storage element 38.

Alternatively, first heat storage element 36 and the second heat storage element 38 being configured to store the first heat energy storage content 33.

Alternatively, first heat storage element 36 and the second heat storage element 38 being configured to store the second heat energy storage content 35.

Alternatively, the first heat storage element 36 is arranged in a first air cooling chamber 1AC of the first cooler zone C1.

Alternatively, the second heat storage element 38 is arranged in a second air cooling chamber 2AC of the second cooler zone C2.

Alternatively, the second heat energy content HE″ of low grade heat (exhaust heat) recovered from the induration apparatus 3 is provided by a heat exchanger apparatus 44 transferring heat from exhaust gases to a process gas carrying the second heat energy content HE″.

Alternatively, exhaust gas from the downdraft drying zone DDD may be called a first cooling air 1AA, which is fed directly or via the heat exchanger apparatus 44 into the first 1AC and/or second air cooling chamber 2AC.

Alternatively, the first 1AC and second air cooling chamber 2AC is configured for cooling the metal oxide material 7 transferred from the induration apparatus 3.

Alternatively, the first cooling air 1AA comprises thermal energy originating from the drying zone DZ of the induration apparatus 3.

Alternatively, the first cooling air 1AA comprises thermal energy originating from the updraft drying zone UDD and/or from the downdraft drying zone DDD of the induration apparatus 3.

Alternatively, the first cooling air 1AA comprises low-grade heat energy originating from a drying chamber DC comprising the drying zone DZ (preferably the downdraft drying zone DDD).

Alternatively, the drying chamber DC is configured to dry the metal ore material.

Alternatively, exhaust gas from the tempered pre-heating zone TPH may be called a second cooling air 2AA, which is fed directly or via the heat exchanger apparatus 44 into the first 1AC and/or second air cooling chamber 2AC.

Alternatively, the second cooling air 2AA comprises thermal energy originating from the heating zone HZ of the induration apparatus 3.

Alternatively, the second cooling air 2AA comprises thermal energy originating from the tempered pre-heating zone TPH.

Alternatively, the second cooling air 2AA comprises low-grade heat energy originating from a tempered pre-heating chamber TC comprising the tempered pre-heating zone TPH.

Alternatively, the tempered pre-heating chamber TC is configured to pre-heat the metal ore material.

Alternatively, exhaust gas from the pre-heating zone PHZ may be called a third cooling air 3AA, which is fed directly or via the heat exchanger apparatus 44 into the first 1AC and/or second air cooling chamber 2AC.

Alternatively, the third cooling air 3AA comprises thermal energy originating from the pre-heating zone PHZ of the induration apparatus 3.

Alternatively, the third cooling air 3AA comprises low-grade heat energy originating from a pre-heating chamber PC comprising the pre-heating zone PHZ.

Alternatively, the pre-heating chamber PC is configured to pre-heat the metal ore material.

Alternatively, the pre-heating chamber PC is configured to oxidize the metal ore material, such as magnetite ore material releasing additional heat energy to the pre-heating chamber PC (oxidizing the magnetite ore material to hematite ore material).

Alternatively, the second heat energy content of the first 1AA and/or second 2AA and/or third 3AA cooling air comprises low-grade heat energy originating from the metal oxide material manufacturing thermal process

Alternatively, the first cooling air 1AA is fed into the first air cooling chamber 1AC and/or the second air cooling chamber 2AC for cooling the metal oxide material 7 transferred from the induration apparatus 3.

Alternatively, a second cooling air 2AA is fed into the first air cooling chamber 1AC and/or the second air cooling chamber 2AC for cooling the metal oxide material 7 transferred from the induration apparatus 3.

Alternatively, a third cooling air 3AA is fed into the first air cooling chamber 1AC and/or the second air cooling chamber 2AC. for cooling the metal oxide material 7 transferred from the induration apparatus 3.

Alternatively, the first cooling air 1AA comprises low-grade heat energy originating from the drying chamber DC of the induration apparatus 3.

Alternatively, the second cooling air 2AA comprises low-grade heat energy originating from the tempered pre-heat chamber TC of the induration apparatus 3.

Alternatively, the third cooling air 3AA comprises low-grade heat energy originating from the pre-heat chamber PC of the induration apparatus 3.

Consequently, the metal oxide material 7 transferred from the induration apparatus 3 into the cooler device 9 is cooled down by the cooler device 9, whereas the first cooling air 1AA and/or the second cooling air 2AA and/or the third cooling air 3AA will be heated by the metal oxide material 7 (transferred from the induration apparatus 3 into the cooler device 9) and/or will be heated by the heat storage element 31 (preferably by the first heat storage element 36 and/or second heat storage element 38).

Consequently, the metal oxide material (e.g. metal conglomerates in the form of pellets) being cooled down in the cooling device 9, wherein the first 1AA and/or second 2AA and/or third cooling air 3AA constituting the second heat energy content HE″ of low-grade heat.

Alternatively, the heat exchanger apparatus 44 is configured to convert heat energy from the exhaust gases (the first 1AA and/or second 2AA and/or third cooling air 3AA) to a process gas carrying the second heat energy content HE″ fed to the first air cooling chamber 1AC and/or the second air cooling chamber 2AC.

Alternatively, a control circuitry of the metal agglomerate production configuration 1 is configured to control combustion fuel usage for heating the metal ore material in the induration apparatus and/or control the metal ore material temperature and/or control the metal ore material oxidation process (e.g. oxidation of magnetite ore), wherein the control circuitry is configured to take into account the first heat energy content HE′ for managing said controlling.

Alternatively, the support member comprises a first cooler zone support member of the first cooler zone, a second cooler zone support member of the second cooler zone, a third cooler zone support member of the third cooler zone, a fourth cooler zone support member of the fourth cooler zone and/or a fifth cooler zone support member of the fifth cooler zone.

By means of introducing the second thermal energy into the support member, the first heat energy content HE′ absorbed by the support member will be reduced in relation to prior art, which in turn means that the metal oxide material will be cooled down more slowly (reduced cooling rate).

Alternatively, the heat energy content HE′ comprises the thermal energy.

Alternatively, the cooler device 9 is configured to cool the metal oxide material discharged from the induration apparatus in a continuously or stepwise cooling procedure in the cooler device 9, which comprises a metal oxide material discharge device 10 configured for discharging cooled metal oxide material 7 from the cooler device.

Alternatively, the cooler device is configured to provide further oxidation of the metal oxide material discharged from the induration apparatus.

Alternatively, the metal oxide material comprises iron oxide material, e.g. magnetite ore, being subject to oxidation releasing further heat energy, dependent upon the oxygen content in the magnetite ore, added to the first heat energy content.

Alternatively, the metal ore material is heated for achieving a pre-heated state of the metal ore material by means of said oxidizing the metal ore material (oxidizing magnetite ore to hematite ore).

Alternatively, the second heat energy content originates from the metal oxide material manufacturing thermal process and comprises waste heat energy, i.e. not used heat energy of the first heat energy content heating the metal ore material and/or not used heat energy of drying gas and/or downdraft drying gas and/or tempered pre-heating medium and/or oxidization of the metal ore material.

Alternatively, the metal ore material is heated by a heated updraft drying gas and/or by a heated downdraft drying gas.

Alternatively, the metal ore material is heated for achieving a pre-heated state of the metal ore material by means of a tempered pre-heating medium (solid or fluid as gas).

Alternatively, the heated updraft drying gas and/or heated downdraft drying gas and/or tempered pre-heating medium is heated by a heating device (such as a gas burner) of the induration apparatus 3.

Alternatively, the heating device comprises a downdraft drying gas heating unit configured to heat the downdraft drying gas.

Alternatively, the heating device comprises a pre-heating medium heating unit configured to heat the metal ore material.

Alternatively, the heating device comprises an oxidation unit configured to oxidize the metal ore material generating heat.

Alternatively, the heating device comprises the furnace device, such as a kiln device or any suitable firing device configured for sintering the metal ore material.

Alternatively, the low-grade heat energy of the second heat energy content HE″ comprises heat energy originating from the oxidization of the metal ore material.

Alternatively, excess heat energy from the furnace device (sintering process) is fed to the pre-heating zone PHZ.

Alternatively, a portion of the second heat energy content is transferred to the first heat energy content.

In such way is achieved that heat storage element 31 of the cooler device 9 will generate additional heat to the drying zone DZ and/or the tempered pre-heat zone TPH and/or the pre-heating zone PHZ for drying/heating the metal ore material, at the same time as the cooling rate for cooling down the metal oxide material in the cooler device 9 will be low.

Alternatively, a first fluid, such as a cooling process gas, is heated by the exhaust gas discharged from the drying zone DZ and/or the tempered pre-heat zone TPH and/or the pre-heating zone PHZ.

Alternatively, a second fluid, such as a heating process gas, is fed from the cooler device to the induration apparatus 3 for adding heat to the metal oxide material manufacturing thermal process.

In such way the cooling air fed to the cooler device 9 will be heated, which implies that the heat storage element 31 will be cooled down slowly, which in turn increases the temperature of the second fluid.

In such way the metal oxide material within the cooler device 9 will be cooled down slowly while being transported through the cooler device, which promotes application of a further cooler zone (externally or internally) for extraction of further heat energy added to the second fluid.

In such way, heat energy from the further cooler zone can be re-used.

In such way the cooler device 9 can be used as a heat storage unit primarily used to feed additional heat energy to the metal oxide material manufacturing thermal process of the induration apparatus 3 in an optimal way.

This is achieved by the heat energy of the second heat energy content HE″ comprising low-grade heat, so called exhaust heat, is recovered from the metal oxide material manufacturing thermal process.

In such way, the thermal energy of the metal oxide material is preserved over long time in the cooler device 9, which implies that further heat energy can be added to the second fluid.

The additional heat energy produced by the heat storage element 31 may be used for increasing the temperature second fluid and/or increasing the mass flow of the second fluid.

Thereby is achieved increased temperature of the metal oxide material manufacturing thermal process.

The temperature of the metal oxide material manufacturing thermal process may in such way reach a temperature of about 1000-1100° C., which implies a cost-effective production of metal oxide material.

Supposing that the heating and/or firing of the metal ore material in the sintering zone requires a temperature of about 1250° C., the thermal work of the fuel used in the metal agglomerate production configuration can be lowered with about 25-30% relatively prior art.

In such way is achieved a decreased cooling rate of the metal oxide material, which in turn implies possibility to add a further cooler zone to the cooler device, which further cooler zone can be used for recovering further heat extracted from the cooler device.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

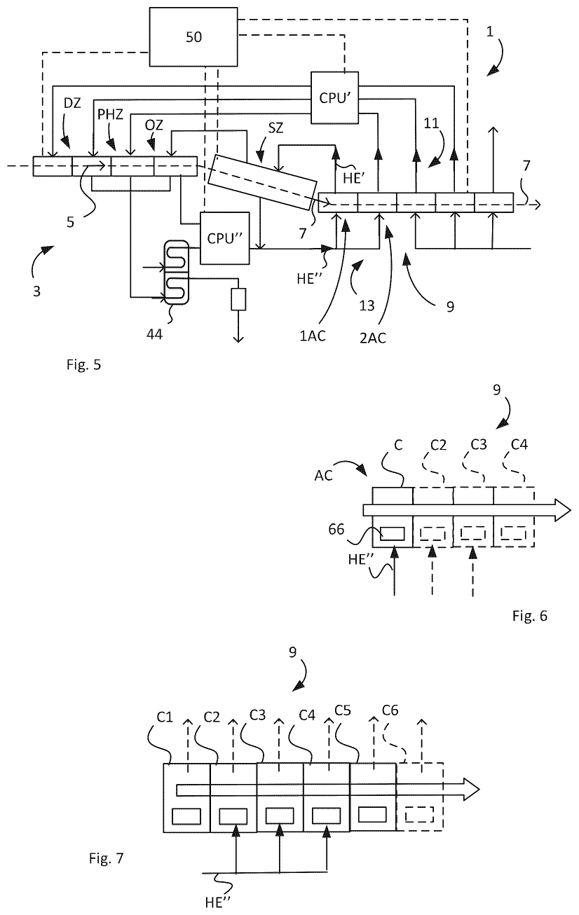

FIG. 5 illustrates a metal agglomerate production configuration 1 according to a fifth example. The metal agglomerate production configuration 1 comprises an induration apparatus 3 configured to provide a metal oxide material manufacturing thermal process comprising indurating a metal ore material 5 into a metal oxide material 7 and configured to discharge the metal oxide material 7, holding thermal energy originating from said metal oxide material manufacturing thermal process, to a cooler device 9 of the configuration 1.

The metal agglomerate production configuration 1 comprises a control circuitry 50 configured to control the metal oxide material manufacturing thermal process and to control the cooler device 9 for optimal cooling rate and re-use of excess heat energy recovered from the induration apparatus 3. The control circuitry is electrically coupled to a first central processor unit CPU′ and is electrically coupled to a second central processor unit CPU″, which are configured to monitor and control the operation of the metal agglomerate production configuration 1.

The cooler device 9 is configured for cooling the metal oxide material 7 discharged from the induration apparatus 3. The cooler device 9 comprises a first heat transferring arrangement 11 configured for transferring a first heat energy content HE′ to the induration apparatus 3.

The first heat energy content HE′ of a first fluid is recovered from the metal oxide material 7 holding said thermal energy. The metal agglomerate production configuration 1 comprises a second heat transferring arrangement 13 configured for transferring a second heat energy content HE″ from the induration apparatus 3 to the cooler device 9.

The second heat energy content HE″ is carried by a process gas (second fluid) and is introduced into the cooler device 9 for cooling the metal oxide material 7. A heat exchanger apparatus 44 is configured to convert heat energy from exhaust gases discharged from a drying zone DZ, a pre-heating zone PHZ, and an oxidization zone OZ of the induration apparatus 3, into the second heat energy content HE″ of the second fluid. The second heat energy content HE″ thus is recovered from the metal oxide material manufacturing thermal process. By means of the second heat energy content HE″, the cooling rate of cooling down the metal oxide material 7 can be decreased relatively prior art. The second heat energy content HE″ comprises low-grade heat energy recovered from the induration apparatus 3. The second heat energy content HE″ partially is added to the first heat energy content HE′.

The second heat transferring arrangement 13 comprises a first air cooling chamber 1AC configured for cooling the metal oxide material 7 in a first step and comprises a second air cooling chamber 2AC configured for cooling the metal oxide material 7 in a second step.

The control circuitry 50 of the metal agglomerate production configuration 1 is configured to control the metal oxide material manufacturing thermal process by taking into account the temperature and/or mass flow of the first heat energy content HE′ and/or the second heat energy content HE″ in an optimal way for energy efficient production of cooled down metal oxide material. The control circuitry 50 may be fed with data from a metal agglomerate production cooling model determined by a metal oxide material production operator or by generative operating data program configured from given parameters from optimal cooling rate for achieving energy-efficient and optimal re-use of excess low-grade heat energy from the induration apparatus 3.

FIG. 6 illustrates a cooler device 9 of a metal agglomerate production configuration according to a sixth example. The cooler device 9 comprises a single cooler zone C of an air cooling chamber AC. A second heat energy content HE″ is recovered from exhaust heat of a metal oxide material manufacturing thermal process and being introduced into the single cooler zone C for decreasing the cooling rate of a cooling metal oxide material.

The cooler device 9 may comprise a second cooler zone C2, a third cooler zone C3, and a fourth cooler zone C4 and the second heat energy content HE″ may be introduced into all cooler zones for heating a respective heater element 66.

FIG. 7 illustrates a cooler device 9 of a metal agglomerate production configuration according to a seventh example. The cooler device 9 comprises a first cooler zone C1, a second cooler zone C2, a third cooler zone C3, a fourth cooler zone C4 and a fifth cooler zone C5. A second heat energy content HE″ is recovered from exhaust heat of a metal oxide material manufacturing thermal process and being introduced into the cooler zones for decreasing the cooling rate of a cooling metal oxide material.

The cooler device 9 may comprise a sixth cooler zone C6 and the second heat energy content HE″ may be introduced into the sixth cooler zone C6 as well.

In such way is achieved a closed loop of heat energy comprising exhaust heat discharged from the induration apparatus, which exhaust heat (comprising the second heat energy content) is used to decrease the cooling rate of cooling the metal oxide material and re-used by the metal oxide material manufacturing thermal process performed by the induration apparatus.

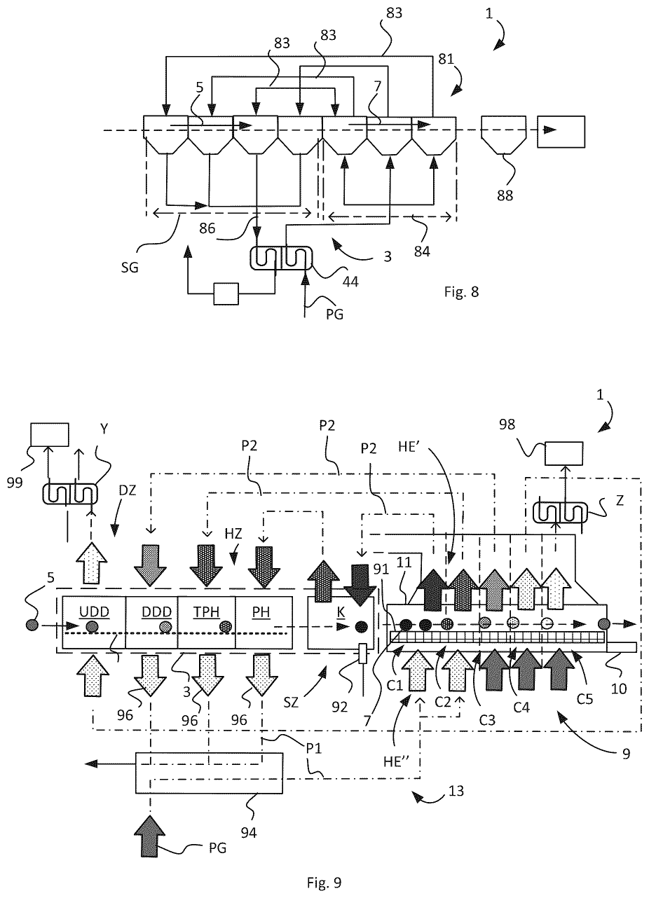

FIG. 8 illustrates a metal agglomerate production configuration 1 according to an eight example. Metal ore material 5 is transferred through a straight grate apparatus 81. A metal oxide material manufacturing thermal process performed by the straight grate apparatus 81 comprises drying, preheating, induration, and cooling. Heat energy from later process steps is circulated back to preceding steps by hot air with a duct and fan system, marked with reference 83. The cooling process is marked with 84. Exhaust heat energy 86 from the drying, preheating, induration process SG is fed to a heat exchanger apparatus 44 for heating a process gas PG fed to the cooling process 84, which heated process gas PG is used for cooling the produced metal oxide material 7 with decreased cooling rate, enabling establishment of further cooling zones 88.

In such way is achieved a closed loop of heat energy comprising exhaust heat energy discharged from the drying, preheating, induration apparatus, which exhaust heat energy is used to cool down the metal oxide material and by means of the heat energy enable to decrease the cooling rate of cooling the metal oxide material. This heat energy thus is re-used by the metal oxide material manufacturing thermal process performed by the induration apparatus.

FIG. 9 illustrates a metal agglomerate production configuration 1 according to a ninth example. The metal agglomerate production configuration 1 comprises an induration apparatus 3 configured to provide a metal oxide material manufacturing thermal process comprising indurating a metal ore material 5 into a metal oxide material 7 and configured to discharge the metal oxide material 7, holding thermal energy originating from said metal oxide material manufacturing thermal process, to a cooler device 9.

The cooler device 9 is configured for cooling the metal oxide material 7 discharged from the induration apparatus 3. The cooler device 9 comprises a first heat transferring arrangement 11 configured for transferring a first heat energy content HE′ to the induration apparatus 3.

The first heat energy content HE′ of a first fluid is recovered from the metal oxide material 7 holding said thermal energy. The metal agglomerate production configuration 1 comprises a second heat transferring arrangement 13 configured for transferring a second heat energy content HE″ from the induration apparatus 3 to the cooler device 9. The cooler device 9 comprises a first cooler zone C1, a second cooler zone C2, a third cooler zone C3, a fourth cooler zone C4 and a fifth cooler zone C5.

Preferably, the second heat energy content HE″ is introduced into the first cooler zone C1 and into the second cooler zone C2 for efficient re-use of heat energy to be transferred back to the induration apparatus 3 from the cooler device 9.

The fifth cooler zone C5 may be used for recovering and transferring excess thermal energy from the cooled down metal oxide material to a first heat exchanger device Z configured for recovering excess thermal energy.

In such way it is achieved that the thermal energy derived from the produced metal oxide material 7 is re-used by the induration apparatus 3.

In such way it is achieved that the thermal energy derived from the produced metal oxide material 7 is re-used by an external commersial heat provider, such as a heat distribution company 98.

The metal agglomerate production configuration 1 may comprise a control circuitry (not shown) configured to control the metal oxide material manufacturing thermal process. The control circuitry of the metal agglomerate production configuration 1 is configured to control said metal oxide material manufacturing thermal process by taking into account the first heat energy content HE′ and/or the second heat energy content HE″.

The induration apparatus 3 comprises a drying zone DZ comprising an updraft drying zone UDD and a downdraft drying zone DDD.

The updraft drying zone UDD may be used for recovering and transferring excess thermal energy from the drying process configured to dry the metal ore material 5 to a second heat exchanger device Y configured for recovering excess thermal energy to be re-used in any suitable facility 99 of the induration apparatus 3.

The induration apparatus 3 further comprises a heating zone HZ configured to pre-heat the metal ore material 5. The heating zone HZ comprises a tempered pre-heating zone TPH and a pre-heating zone PH. The induration apparatus 3 further comprises a kiln unit K configured for oxidizing and sintering the metal ore material. The kiln unit K comprises a heating burner element 92.

The second heat energy content HE″, recovered from the downdraft drying zone DDD, the tempered pre-heating zone TPH and the pre-heating zone PH, thus is transferred to the cooler device 9 to decrease the cooling rate of the metal oxide material 7. Exhaust heat energy 96 from the downdraft drying, tempered pre-heating, and pre-heating process is fed to a heat exchanger apparatus 94 for heating a process gas PG transferred to the cooler device 9, which heated process gas PG is used for cooling the produced metal oxide material 7 with decreased cooling rate. The second heat energy content HE″ comprises low-grade heat energy recovered from the induration apparatus 3.

The cooler device 9 comprises a heat storage element 91 configured to store a first heat energy storage content, transferred from the metal oxide material 7 to the heat storage element 91, which metal oxide material 7 is discharged from the induration apparatus into the cooler device 9. The heat storage element 91 is further configured to store a second heat energy storage content of the second heat energy content HE″ transferred from the induration apparatus 3 via the second heat transferring arrangement 13.

Alternatively, the second heat energy content HE″ partially is added to the first heat energy content HE′ via the heat storage element 91.

Alternatively, the heat storage element 91 is configured to completely or partially store the first heat energy content HE′ and/or completely or partially store the second heat energy content HE″ and/or completely or partially store the first heat energy storage content and/or completely or partially store the second heat energy storage content. The heat storage element 91 is formed as a support member configured to support the metal oxide material 7 transferred through the cooler device 9. The heat storage element 91 is configured to store thermal energy from the metal oxide material 7 and is configured to store the second heat energy content HE″.

Alternatively, the first heat energy content HE′ constitutes a portion of the thermal energy of the metal oxide material originating from said metal oxide material manufacturing thermal process.

The heat storage element 91 is configured to emit the first heat energy content HE′ to the induration apparatus.

The second heat transferring arrangement 13 comprises a first air cooling chamber (first cooler zone C1) configured for cooling the metal oxide material 7 in a first step and comprises a second air cooling chamber (second cooler zone C2) configured for cooling the metal oxide material 7 in a second step.

The heat exchanger unit 94 of the second heat transferring arrangement 13 is coupled between the induration apparatus 3 and the cooler device 9 via a first pipe arrangement P1.

The cooler device 9 is coupled to the induration unit 3 via a second pipe arrangement P2.

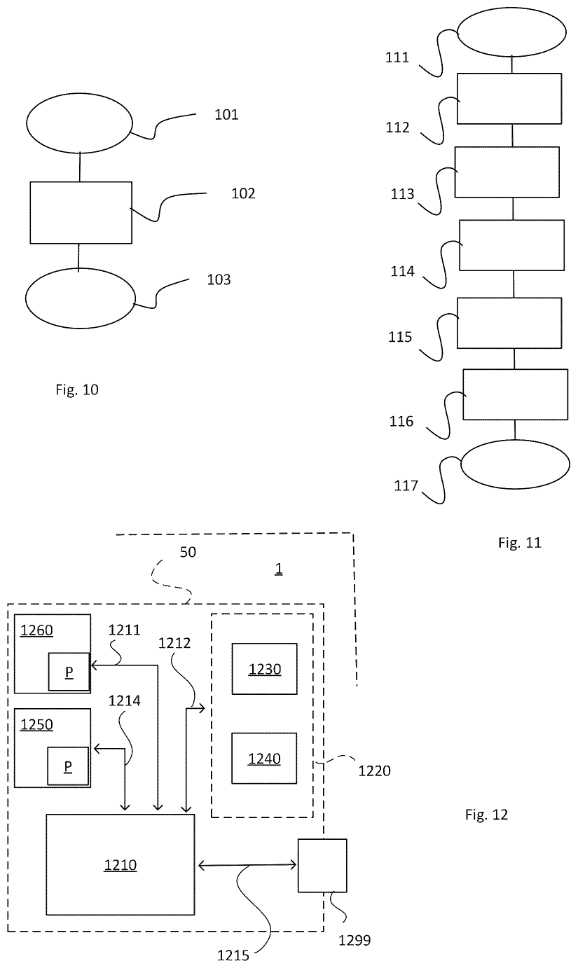

FIG. 10 illustrates a flowchart showing an exemplary method of production of metal agglomerates by means of a metal agglomerate production configuration comprising an induration apparatus configured to provide a metal oxide material manufacturing thermal process comprising indurating a metal ore material into a metal oxide material and configured to discharge the metal oxide material, holding thermal energy originating from said metal oxide material manufacturing thermal process, to a cooler device of the configuration; a control circuitry configured to control the metal oxide material manufacturing thermal process; the cooler device is configured for cooling the metal oxide material discharged from the induration apparatus; the cooler device comprises a first heat transferring arrangement configured for transferring a first heat energy content to the induration apparatus, which first heat energy content is recovered from the metal oxide material holding said thermal energy. A second heat transferring arrangement is configured for transferring a second heat energy content from the induration apparatus to the cooler device for cooling down the metal oxide material, which second heat energy content is recovered from the metal oxide material manufacturing thermal process. In step 101 the method is started. In step 102 the method is performed. In step 103 the method is stopped.

Step 102 may comprise; indurating the metal ore material into the metal oxide material; transferring the second heat energy content from the induration apparatus to the cooler device; cooling the metal oxide material discharged from the induration apparatus; transferring the first heat energy content to the induration apparatus for said metal oxide material manufacturing thermal process, and discharging the metal oxide material from the cooler device.

FIG. 11 illustrates a flowchart showing an exemplary method of production of metal agglomerates by means of a metal agglomerate production configuration referred to in FIG. 10. In step 111 the method is started. Step 112 comprises indurating the metal ore material into the metal oxide material. Step 113 comprises transferring the second heat energy content from the induration apparatus to the cooler device. Step 114 comprises cooling the metal oxide material discharged from the induration apparatus. Step 115 comprises transferring the first heat energy content to the induration apparatus for said metal oxide material manufacturing thermal process. Step 116 comprises discharging the metal oxide material from the cooler device. In step 117 the method is stopped.

The method may comprise the steps of storing the thermal energy and the second heat energy content by means of a heat storage element of the cooler device and emitting the first heat energy content from the cooler device to the induration apparatus.

FIG. 12 illustrates a control circuitry 50 of a metal agglomerate production configuration 1 shown in e.g. FIG. 5. The control circuitry 50 may comprise a central processor unit electrically coupled to a plurality of sensors and control circuits of the metal agglomerate production configuration 1 for operating the metal agglomerate production configuration 1.

For example, each cooler zone may comprise a respective temperature sensor electrically coupled to the control circuitry 50.

The control circuitry 50 may comprise a computer, which comprises a non-volatile memory NVM 1220 constituting a computer memory that can retain stored information even when the computer is not powered. The NVM 1220 comprises a first memory unit 1230. The control circuitry 50 further comprises a processing unit 1210 and a read/write memory 1250.

A computer program (which can be of any type suitable for any operational database) is stored in the first memory unit 1230 for controlling the functionality of the control circuitry 50. Furthermore, the control circuitry 50 comprises a bus controller (not shown), a serial communication port (not shown) providing a physical interface, through which information transfers separately in two directions. The control circuitry 50 also comprises any suitable type of I/O module (not shown) providing input/output signal transfer, an A/D converter (not shown) for converting continuously varying signals from the sensors (not shown) of the metal agglomerate production configuration 1 into binary code suitable for the computer.

The control circuitry 50 also comprises an input/output unit (not shown) for adaption to time and date. The control circuitry 50 further comprises an event counter (not shown) for counting the number of event multiples that occur from independent cooling sequences of the metal oxide material cooled down by the cooler device.

Furthermore, the control circuitry 50 comprises interrupt units (not shown) associated with the computer for providing a multi-tasking performance and real time computing. The NVM 1220 also includes a second memory unit 1240 for external controlled operation.

A data medium storing program P comprising driver routines is adapted for controlling gas flow valves (not shown) of the first and second heat transferring arrangements, the fan system configured to feed the first and second heat energy content, induration temperature control. The driver routines are provided for operating the control circuitry 50 for performing any exemplary method step described herein. The driver routines may be adapted for providing an automatic or semi-automatic manufacture of cooled down metal oxide material.

The data medium storing program P comprises a program code stored on a medium, which is readable on the computer, for causing the computer to perform a method of: indurating the metal ore material into the metal oxide material; transferring the second heat energy content from the induration apparatus to the cooler device; cooling the metal oxide material discharged from the induration apparatus; transferring the first heat energy content to the induration apparatus for said metal oxide material manufacturing thermal process, and discharging the metal oxide material from the cooler device.

The data medium storing program P further may be stored in a separate memory 1260 and/or in a read/write memory 1250. The data medium storing program P is in this example stored in executable or compressed data format.

It is to be understood that the processing unit 1210 may execute a specific function that involves that the processing unit 1210 executes a certain part of the program stored in the separate memory 1260 or a certain part of the program stored in the read/write memory 1250.

The processing unit 1210 is associated with a data port 1299 for communication via a first data bus 1215. The non-volatile memory NVM 1220 is adapted for communication with the processing unit 1210 via a second data bus 1212. The separate memory 1260 is adapted for communication with the processing unit 1210 via a third data bus 1211. The read/write memory 1250 is adapted to communicate with the processing unit 1210 via a fourth data bus 1214. The data port 1299 may be connectable to data links of the metal agglomerate production configuration 1 shown in e.g. FIG. 5.

When data is received by the data port 1299, the data will be stored temporary in the second memory unit 1240. After that the received data is temporary stored, the processing unit 1210 will be ready to execute the program code, in accordance with the above-mentioned steps.

Preferably, the signals (received by the data port 1299) comprise information about operational status of the metal agglomerate production configuration 1, such as operational status regarding e.g. the temperatures in different cooler zones, cooling rates, gas flows, metal oxide material discharge rate, actual heat energy recovering status, etc.

The signals can be used by the control circuitry 50 for controlling and monitoring a semi-automatic or automatic metal agglomerate production configuration 1 in a cost-effective way.

The information may be measured by means of the sensors and/or may be manually fed to the control circuitry 50 via a suitable communication device, such as a personal computer display.

Parts of the method can also be executed by the control circuitry 50, wherein the computer runs the data medium storing program P being stored in the separate memory 1260 or the read/write memory 1250. When the computer runs the program P, suitable method steps disclosed herein will be executed. A data medium for storing the program P may be provided, which data medium is readable on the computer.

The disclosure is of course not in any way restricted to the examples described above, but many possibilities to modifications, or combinations of the described examples, thereof should be apparent to a person with ordinary skill in the art without departing from the basic idea of the invention as defined in the appended claims.

1. A metal agglomerate production configuration, comprising:
an induration apparatus configured to provide a metal oxide material manufacturing thermal process (MTE) comprising indurating a metal ore material into a metal oxide material and configured to discharge the metal oxide material, holding thermal energy (TE) originating from said metal oxide material manufacturing thermal process (MTE), to a cooler device of the configuration;
a control circuitry configured to control the metal oxide material manufacturing thermal process;
the cooler device is configured for cooling the metal oxide material discharged from the induration apparatus;
the cooler device comprises a first heat transferring arrangement configured for transferring a first heat energy content (HE′) to the induration apparatus, which first heat energy content (HE′) is recovered from the metal oxide material holding said thermal energy (TE); the configuration is characterized by;
a second heat transferring arrangement configured for transferring a second heat energy content (HE″) from the induration apparatus to the cooler device for cooling of the metal oxide material, which second heat energy content (HE″) is recovered from the metal oxide material manufacturing thermal process (MTE).

2. The metal agglomerate production configuration according to claim 1, wherein the second heat energy content (HE″) comprises low-grade heat energy recovered from the induration apparatus.

3. The metal agglomerate production configuration according to claim 1, wherein the second heat energy content (HE″) completely or partially is added to the first heat energy content (HE′).

4. The metal agglomerate production configuration according to claim 1, wherein the second heat transferring arrangement comprises a first air cooling chamber (1AC) configured for cooling the metal oxide material in a first step and comprises a second air cooling chamber (2AC) configured for cooling the metal oxide material in a second step.

5. The metal agglomerate production configuration according to claim 1, wherein a heat exchanger of the second heat transferring arrangement is coupled between the induration apparatus and the cooler device.

6. The metal agglomerate production configuration according to claim 1, wherein the control circuitry of the metal agglomerate production configuration is configured to control said metal oxide material manufacturing thermal process by taking into account the first heat energy content (HE′) and/or the second heat energy content (HE″).

7. A method of production of metal agglomerates by the metal agglomerate production configuration according to claim 1, the method comprises:
indurating the metal ore material into the metal oxide material;
transferring the second heat energy content (HE″) from the induration apparatus to the cooler device;
cooling the metal oxide material discharged from the induration apparatus;
transferring the first heat energy content (HE′) to the induration apparatus for said metal oxide material manufacturing thermal process (MTE), and
discharging the metal oxide material from the cooler device.

8. The method according to claim 7, wherein the second heat energy content (HE″) comprises low-grade heat energy recovered from the induration apparatus.

9. The method according to claim 7, wherein the second heat energy content (HE″) completely or partially is added to the first heat energy content (HE′).

10. The method according to claim 7, wherein said cooling comprises:
storing the thermal energy (TE) and the second heat energy content (HE″) by a heat storage element of the cooler device;
emitting the first heat energy content (HE′) from the cooler device to the induration apparatus.

11. A data medium storing a data program (P), programmed for causing the metal agglomerate production configuration according to claim 1 to execute an automatic or semi-automatic manufacture of metal oxide material, wherein said data program (P) comprises a program code, the data medium is readable on a computer of the control circuitry, for causing the control circuitry to perform the method comprising:
indurating the metal ore material into the metal oxide material;
transferring the second heat energy content (HE″) from the induration apparatus to the cooler device;
cooling the metal oxide material discharged from the induration apparatus;
transferring the first heat energy content (HE′) to the induration apparatus for said metal oxide material manufacturing thermal process (MTE); and
discharging the metal oxide material from the cooler device.

12. A data medium product comprising a data program (P) and a program code stored on a data medium of the data medium product, said data medium is readable on a computer of the control circuitry, for performing the method according to claim 7, when the data program (P) of the data medium according to claim 1 is run on the computer.
